(19) United States
(12) Patent Application Publication
(10) Pub. No.: US 2008/0172517 A1
(43) Pub. Date: Jul. 17, 2008

(54) Mask-Programmable Memory with Reserved Space

(76) Inventor: Guobiao ZHANG, Carson City, NV (US)

Correspondence Address: GUOBIAO ZHANG, P.O. BOX 6182, STATELINE, NV, 89449-6182, US

(21) Appl. No.: 11/736,773

(22) Filed: Apr. 18, 2007

Related U.S. Application Data
(60) Provisional application No. 60/884,618, filed on Jan. 11, 2007.

(51) Int. Cl. G06F 12/00

(52) U.S. Cl. 711/103

(57) ABSTRACT

The present invention discloses a mask-programmable memory with reserved space (RS-MPM). It is released in a sequence of versions. In the original version, its storage space comprises a reserved space, which does not store any meaningful information. In the later version, the reserved space stores new release. RS-MPM can be readily applied to three-dimensional memory (3D-M) and three-dimensional memory module (3D-MM).

### CROSS-REFERENCE TO RELATED APPLICATIONS

This application is related to a U.S. Patent Application 60/884,618, “Mask-Programmable Memory with Reserved Space”, filed Jan. 11, 2007.

### BACKGROUND

1. Technical Field of the Invention

The present invention relates to the field of integrated circuits, and more particularly to mask-programmable memory.

2. Related Arts

During the manufacturing of mask-programmable memory (MPM, also known as mask-ROM), the information to be stored is coded into an info-mask and then transferred to the MPM. With a large capacity and low cost, MPM is an ideal storage medium for multimedia contents. Multimedia contents could be textual (e.g. books), audio (e.g. songs), image (e.g. GPS maps, photos), video (e.g. movies) and others.

Because new multimedia contents are being constantly released, MPM needs to be released in a sequence of versions. The contents of the original-version MPM is referred to as initial release. The contents of the later-version MPM includes not only initial release, but also new release. As an example, FIGS. 1A-1B illustrate the original and second versions of a prior-art MPM module 10. The original version uses two MPM chips 12a, 12b to store initial release (including files 8a, 8b, 8c and 8d, 8e). The second version uses an additional MPM chip 12x to store new release (including files 8x, 8y). Using an additional chip will incur additional module footprint and extra design and manufacturing costs. To overcome this and other shortcomings, the present invention discloses a mask-programmable memory with reserved space (RS-MPM).

### OBJECTS AND ADVANTAGES

It is a principle object of the present invention to provide a mask-programmable memory (MPM) that can be easily upgraded to a new version.

It is a further object of the present invention to provide an MPM that can easily add new releases.

It is a further object of the present invention to provide an MPM that can easily upgrade contents.

In accordance with these and other objects of the present invention, a mask-programmable memory with reserved space (RS-MPM) is disclosed.

### SUMMARY OF THE INVENTION

The present invention discloses a mask-programmable memory with reserved space (RS-MPM). It is released in a sequence of versions. In the original version, its storage space comprises an initial-release space and a reserved space. The initial-release space stores the initial release of the multimedia contents, while the reserved space does not store any meaningful information. The mask area corresponding to this reserved space is also reserved. It is either fully dark or fully clear. In the later version, the mask pattern corresponding to new release is formed in the reserved mask area. As a result, the reserved space stores new release. RS-MPM can be easily applied to three-dimensional memory (3D-M) and three-dimensional memory module (3D-MM).

### BRIEF DESCRIPTION OF THE DRAWINGS

FIG. 1A illustrates a prior-art MPM module in its original version; FIG. 1B illustrates said MPM module in its second version;

FIG. 2A illustrates the relative size of the prior-art MPM capacity and user needs; FIG. 2B illustrates the relative growth trend of the MPM capacity and user needs; FIG. 2C illustrates the relative size of the 3D-M (three-dimensional memory) capacity and user needs;

FIG. 3A is a cross-sectional view of a preferred three-dimensional memory (3D-M) with reserved space (RS-3DM) in its original version; FIG. 3B illustrates the corresponding mask pattern at memory level 400;

FIG. 4A is a cross-sectional view of the preferred RS-3DM in its second version; FIG. 4B illustrates the corresponding mask pattern at memory level 400;

FIG. 5A is a cross-sectional view of a preferred RS-3DM with a fully reserved memory level in its original version; FIG. 5B is a cross-sectional view of another preferred RS-3DM with a fully reserved memory level in its original version;

FIG. 6 is a cross-sectional view of the preferred RS-3DM with a fully reserved memory level in its second version;

FIG. 7A illustrates a preferred three-dimensional memory module (3D-MM) with reserved space (RS-3DMM) in its original version; FIG. 7B illustrates the preferred RS-3DMM in its second version;

FIG. 8 illustrates a preferred method to upgrade contents stored in the RS-MPM.

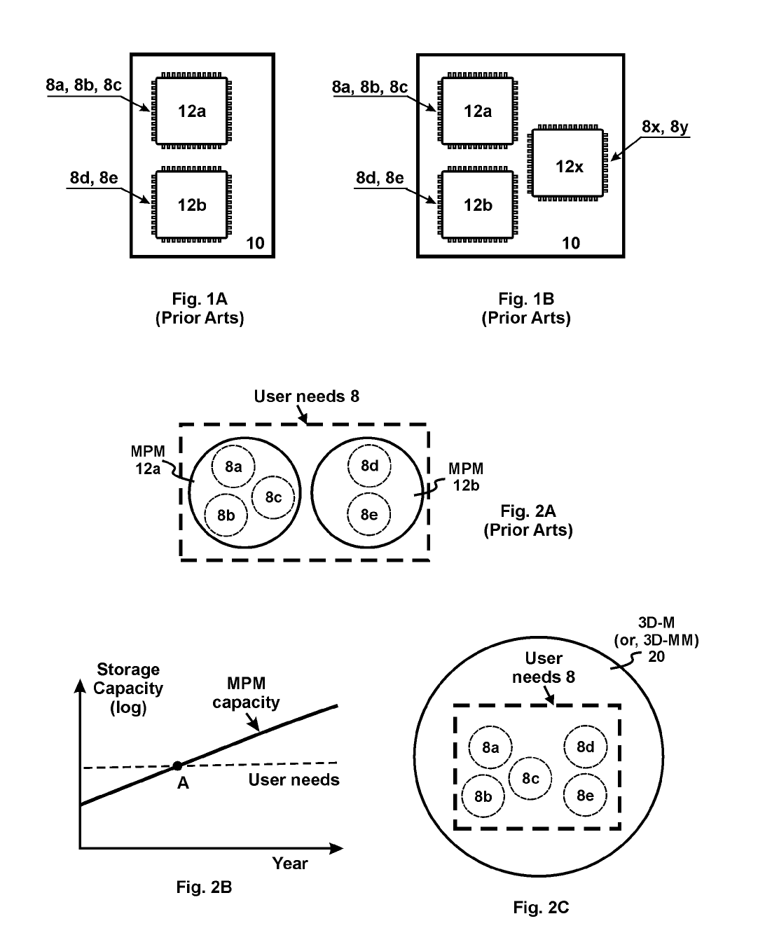

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

The storage capacity of the prior-art mask-programmable memory (MPM) is limited. In order to satisfy the user needs 8, a number of MPM chips are needed. In the example of FIG. 2A, two MPM chips are needed to satisfy the user needs (including files 8a-8e): the MPM chip 12a for files 8a, 8b, 8c, and the MPM chip 12b for files 8d, 8e.

As integrated-circuit technology progresses, the MPM capacity increases rapidly. On the other hand, with further development of compression techniques, the user needs 8 increase at a much slower pace. As illustrated in FIG. 2B, at or after threshold point A, only a single (or a small number of) MPM chip can satisfy the user needs 8.

A potential memory technology that can soon reach this threshold point A is three-dimensional memory (3D-M, referring to U.S. Pat. Nos. 5,835,396, 6,717,222 and others), more particularly, three-dimensional mask-programmable memory (3D-MPM): at the 50 nm node, a single 3D-MPM chip can reach a storage capacity of ˜16 GB; at the 17 nm node, it could reach ˜128 GB. Combined with three-dimensional memory module (3D-MM) technology (referring to U.S. Patent Application 60/767,573), a 3D-M-based 3D-MM (i.e. (3D)²-MM) can reach a storage capacity of ˜1 TB at the 17 nm node. As a result, even after satisfying user needs 8, 3D-M (or, 3D-MM) 20 can still have a large portion of blank storage space at its disposal. This blank storage space can be explored to store new release (FIG. 2C).

The present invention discloses a mask-programmable memory with reserved space (RS-MPM). It is released in a sequence of versions. In the original version, its storage space comprises an initial-release space and a reserved space. The initial-release space stores the initial release of the multimedia contents, while the reserved space does not store any meaningful information. The mask area corresponding to this reserved space is also reserved. It is either fully dark or fully clear. In the later version, the mask pattern corresponding to new release is formed in the reserved mask area. As a result, the reserved space stores new release.

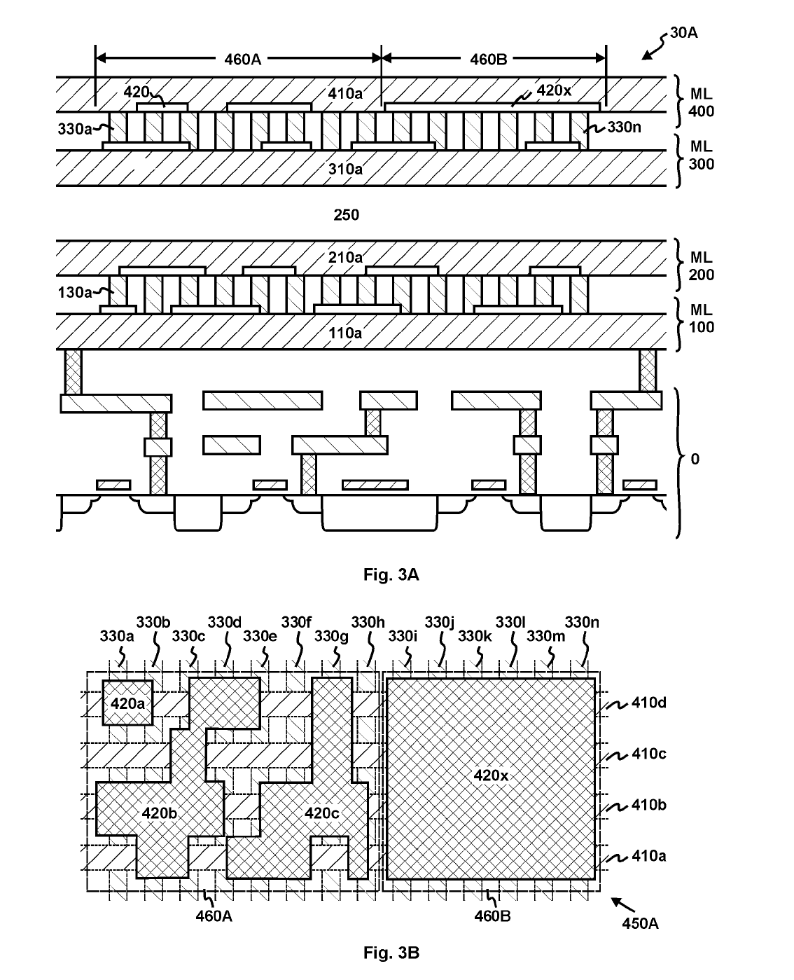

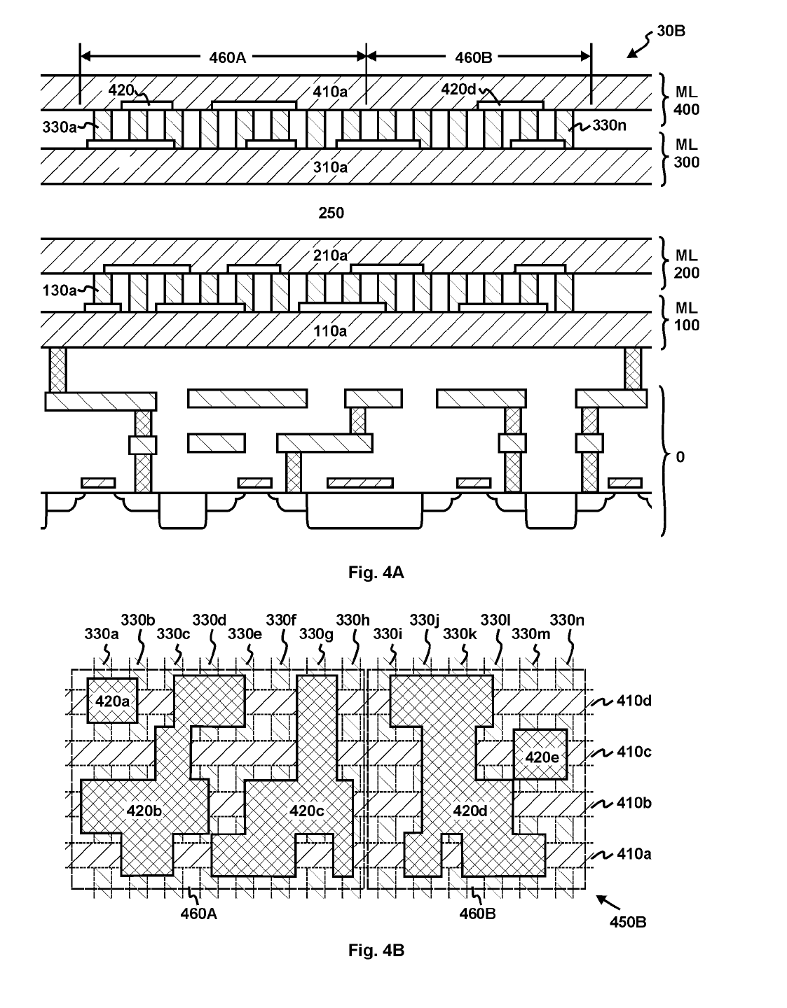

FIGS. 3A-4B illustrate a preferred 3D-M with reserved space (RS-3DM) in its original version 30A and second version 30B. It comprises four vertically stacked memory levels 100-400. These memory levels 100-400 are further stacked above the substrate 0. Each memory level (e.g. 400) is mask-programmable. It comprises word lines (e.g. 410a-410d), bit lines (e.g. 330a-330n) and info-dielectric (420, including 420a-420c, 420x). The patterns in the info-dielectric are transferred from the info-masks (450A of FIG. 3B or 450B of FIG. 4B) and determine the information stored in each memory cell: for a memory cell with no opening in the info-dielectric, it stores “0”; otherwise it stores “1”.

This preferred 3D-MPM (30A, 30B) uses a number of ways to increase storage capacity and lower manufacturing cost, including: 1) nF-opening (n>1), i.e. the dimension of the opening in the info-dielectric is larger than the width of the address line F (referring to U.S. Pat. No. 6,903,427); 2) N-ary MPM (N>2), i.e. each MPM cell has N states and stores more than one bit (referring to U.S. patent application Ser. No. 11/162,262); 3) hybrid-level 3D-M, i.e. some memory levels share address lines (e.g. memory levels 200, 100 share address line 130a), while other memory levels do not (e.g. memory levels 300, 200 are separated by an inter-level dielectric 250) (referring to China, P.R. Patent Application 200610162698.2).

FIGS. 3A-3B are the cross-sectional view of RS-3DM 30A in its original version and the corresponding mask pattern 450A at memory level 400. Here, the combined storage space formed by memory levels 100-300 and area 460A of memory level 400 is referred to as initial-release space. It stores the initial release of multimedia contents. The storage space formed by area 460B of memory level 400 is referred to as reserved space. It does not store any meaningful information. The mask area 420x corresponding to this reserved space is also reserved. It is either all dark or all clear (FIG. 3B).

FIGS. 4A-4B are the cross-sectional view of RS-3DM 30B in its second version and the corresponding mask pattern 450B at memory level 400. Here, the initial-release space remains the same, but the mask pattern 420d, 420e corresponding to new release is formed in area 460B (FIG. 4B). This means new release is stored in the reserved space. Accordingly, this second-version RS-3DM 30B carries not only initial release, but also new release (FIG. 4A). Because it incurs extra cost to form the mask pattern in the reserved mask area, all reserved mask areas are preferably combined into a single or just a small number of info-masks. Preferably, there is no reserved space in at least one memory level which stores initial release.

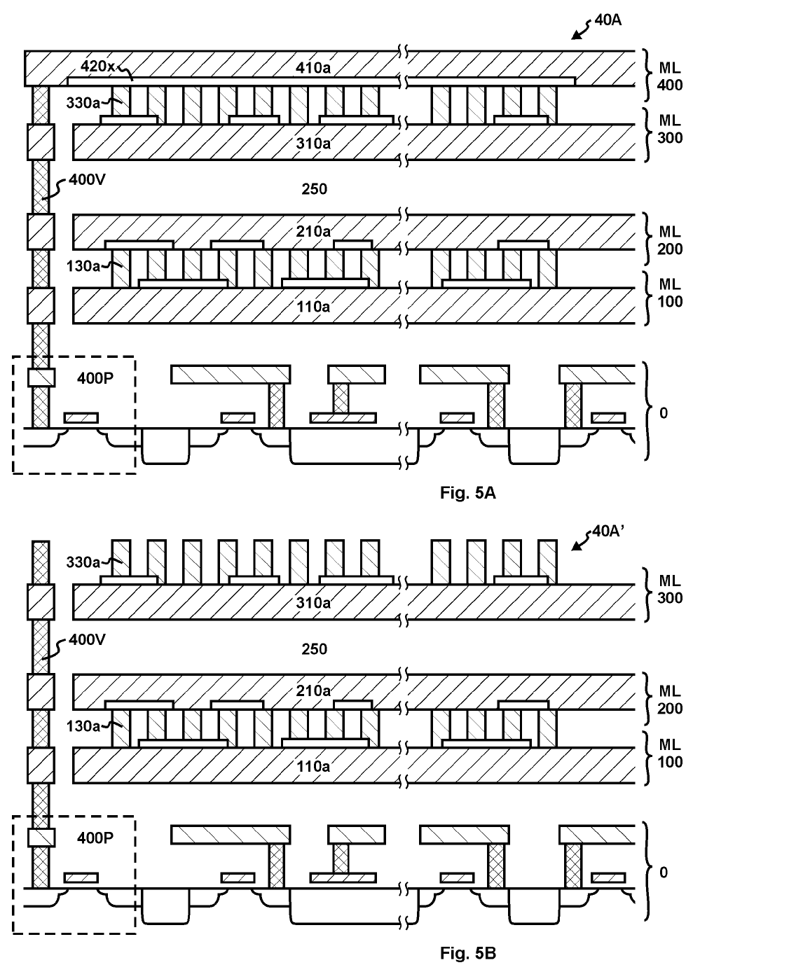

Besides reserving a partial memory level 460B for new release, the present invention further discloses a RS-3DM with at least one fully reserved memory level. FIGS. 5A-5B illustrate two preferred RS-3DMs (40A, 40A′) with a fully reserved memory level (ML 400). They are in their original versions and designed to accommodate four memory levels 100-400. The combined storage space formed by memory levels 100-300 is the initial-release space, while the storage space formed by memory level 400 is the reserved space. Memory level 400 could take various forms. In FIG. 5A, memory level 400 is dummy, where all info-dielectric 420x in memory level 400 is intact, i.e. with no openings therein. In FIG. 5B, the word lines (e.g. 410a) for memory level 400 are absent. Apparently, the RS-3DM 40A′ has less manufacturing cost. Note that the preferred embodiment in FIG. 5B still comprises a number of components for memory level 400, e.g. contact via 400V (which connects word line 410a to the substrate 0) and peripheral circuit 400P. Although these components are not used in the original version, they are needed for the second version of the RS-3DM.

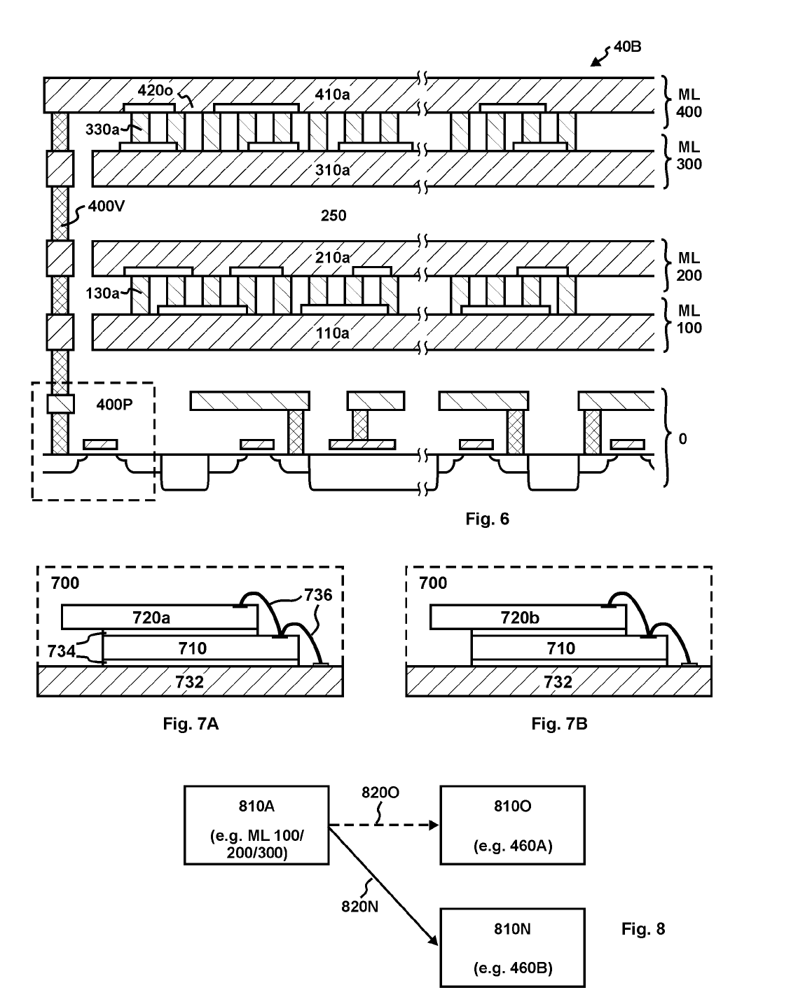

FIG. 6 illustrates the preferred RS-3DM with a fully reserved memory level in its second version. Compared with FIGS. 5A-5B, openings 420o are formed at the selected locations of info-dielectric 420x in memory level 400. Moreover, word lines 410a are also formed for memory level 400. The resulting memory level 400 carries the new release of the multimedia contents.

In the preferred embodiments of FIGS. 3A-6, the original release is stored in the lower memory levels and new release is stored in the upper memory level(s). In other words, the original release is stored in memory levels closer to the substrate 0 than new release. This arrangement provides fast turn-around time for the later-version RS-3DM. In a mass-production environment, batches of base wafers are manufactured up to memory level 300 and stocked by the vendor. Once a new release of the multimedia contents is available, only memory level 400 needs to be manufactured. Because only a small number of memory levels are involved, fast turn-around time can be ensured.

A three-dimensional memory module (3D-MM) comprises a plurality of vertically stacked memory chips (referring to U.S. Patent Application 60/767,573). 3D-M-based 3D-MM (i.e. (3D)²-MM) is a 3D-MM comprising a plurality of vertically stacked 3D-M chips. 3D-MM, particularly (3D)²-MM, has an extremely large storage capacity (up to ˜1 TB) and is suitable to store various multimedia libraries. The present invention further discloses a 3D-MM with reserved space (RS-3DMM). It provides a storage medium with an extremely large capacity and at a low cost while still can be easily upgraded to a new version.

FIG. 7A illustrates a preferred RS-3DMM 700 in its original version. It comprises at least a RS-MPM in its original version 720a and a second memory chip 710. The RS-MPM 720a could be a RS-3DM (FIGS. 3A-6). The second memory chip 710 could be a conventional MPM (i.e. without reserved space), another RS-MPM or a read-write memory (RWM). RWM could be non-volatile memory such as flash memory. It can be used to store new release without replacing RS-MPM 720a. These memory chips 720a, 710 are attached to each other by adhesive layer 734 and make electrical contact to each other and substrate 732 through bond wires 736. FIG. 7B illustrates the preferred RS-3DMM in its second version. It comprises a RS-MPM in its second version 720b and the second memory chip 710. New release is stored in the reserved space of the RS-MPM 720b.

Besides adding new releases, RS-MPM can also be used to upgrade contents. FIG. 8 illustrates a preferred upgrading method. In its original version, initial release comprises data 810A (stored in memory levels 100-300) and data 810O (stored in the area 460A of memory level 400). In its second version, data 810O becomes obsolete and needs to be replaced by new data 810N (e.g. software upgrade, map upgrade). This can be implemented by transferring the mask pattern corresponding to new data 810N to the reserved mask area 460B. Furthermore, RS-MPM comprises a pointer. During upgrade, it changes from 820O to 820N, i.e. from pointing to obsolete data 810O to new data 810N.

While illustrative embodiments have been shown and described, it would be apparent to those skilled in the art that may more modifications than that have been mentioned above are possible without departing from the inventive concepts set forth therein. The invention, therefore, is not to be limited except in the spirit of the appended claims.

What is claimed is:

1. A mask-programmable memory (MPM) with reserved space (RS-MPM), comprising:
an initial-release space, wherein said initial-release space stores initial release; and
a reserved space, wherein said reserved space does not store any meaningful information in the original version of said RS-MPM, and stores new release in the later version of said RS-MPM.

2. The RS-MPM according to claim 1, wherein the info-mask for said RS-MPM comprises a reserved mask area corresponding to said reserved space.

3. The RS-MPM according to claim 2, wherein said reserved mask area is all dark or all clear in the original version of said RS-MPM.

4. The RS-MPM according to claim 2, wherein said reserved mask area comprises the mask pattern corresponding to said new release in the later version of said RS-MPM.

5. The RS-MPM according to claim 1, further comprising a pointer, wherein said pointer selectively points to either said initial-release space or said reserved space.

6. A three-dimensional memory (3D-M) with reserved space (RS-3DM), comprising first and second vertically stacked mask-programmable memory levels, said RS-3DM further comprising:
an initial-release space, wherein said initial-release space stores initial release; and
a reserved space, wherein said reserved space does not store any meaningful information in the original version of said RS-3DM, and stores new release in the later version of said RS-3DM.

7. The RS-3DM according to claim 6, wherein the info-mask for said second memory level comprises a reserved mask area corresponding to said reserved space.

8. The RS-3DM according to claim 7, wherein said reserved mask area is all dark or all clear in the original version of said RS-3DM.

9. The RS-3DM according to claim 7, wherein said reserved mask area comprises the mask pattern corresponding to said new release in the later version of said RS-3DM.

10. The RS-3DM according to claim 7, wherein the info-mask for said first memory level comprises no reserved space.

11. The RS-3DM according to claim 10, wherein said first memory level is located closer to the substrate of said 3D-M than said second memory level.

12. The RS-3DM according to claim 6, further comprising a pointer, wherein said pointer selectively points to either said initial-release space or said reserved space.

13. A three-dimensional memory module (3D-MM) with reserved space (RS-3DMM), comprising a first mask-programmable memory chip and a second memory chip, wherein said first and second memory chips are vertically stacked, said RS-3DMM further comprising:
an initial-release space, wherein said initial-release space stores initial release; and
a reserved space, wherein said reserved space does not store any meaningful information in the original version of said RS-3DMM, and stores new release in the later version of said RS-3DMM.

14. The RS-3DMM according to claim 13, wherein the info-mask for said first memory chip comprises a reserved mask area corresponding to said reserved space.

15. The RS-3DMM according to claim 14, wherein said reserved mask area is all dark or all clear in the original version of said RS-3DMM.

16. The RS-3DMM according to claim 14, wherein said reserved mask area comprises the mask pattern corresponding to said new release in the later version of said RS-3DMM.

17. The RS-3DMM according to claim 13, wherein said first memory chip is a three-dimensional memory (3D-M) with reserved space (RS-3DM).

18. The RS-3DMM according to claim 13, wherein said second memory chip is a conventional mask-programmable memory (MPM) or another mask-programmable memory with reserved space (RS-MPM).

19. The RS-3DMM according to claim 13, wherein said second memory chip is a read-write memory (RWM).

20. The RS-3DMM according to claim 13, further comprising a pointer, wherein said pointer selectively points to either said initial-release space or said reserved space.
